(19) United States
(12) Patent Application Publication
(10) Pub. No.: US 2020/0064271 A1
(43) Pub. Date: Feb. 27, 2020

(54) SENSOR FOR MEASURING CONCENTRATION OF OBJECT SUBSTANCE BY COLOR CHANGE, SENSING SYSTEM COMPRISING SAME, AND METHOD FOR MANUFACTURING SAME SENSOR

(71) Applicant: Samsung Electronics Co., Ltd., Gyeonggi-do (KR)

(72) Inventors: Hee-jin PARK, Seoul (KR); Jee-yeon KIM, Seoul (KR); Yong-won JEONG, Seoul (KR)

(21) Appl. No.: 16/349,896

(22) PCT Filed: Nov. 20, 2017
(86) PCT No.: PCT/KR2017/013199

§ 371 Date: May 14, 2019

(30) Foreign Application Priority Data
Nov. 18, 2016 (KR) 10-2016-0154230

(51) Int. Cl. G01N 21/78; G08B 21/14

(52) U.S. Cl. CPC G01N 21/78; G08B 21/14

(57) ABSTRACT

Disclosed is a sensor for measuring a concentration of an object substance by a color change. The sensor comprises: a pad; and a support member having the pad attached thereto, wherein the pad is dried after being immersed in a solution containing an ionic substance consisting of an ionized indicator dye and ‘an ion having an opposite polarity to the ionized indicator dye among a cation and an anion constituting the ionic liquid’.

### TECHNICAL FIELD

The disclosure relates to a sensor for measuring a concentration of an object substance by a color change, a sensing system including the sensor and a method for manufacturing the sensor, and more specifically, to a sensor for measuring a concentration of an object substance by a color change, which is manufactured to be resistant to water, a sensing system including the same and a method for manufacturing the sensor.

### BACKGROUND ART

As a sensor technology develops rapidly, a sensor has been used in various fields. Especially, the sensors which are easily manufactured and using a cheap substance have been spotlighted, and among the sensors, the application possibility of the development of a sensor using an indicator dye has highly stood out. The indicator dye is a substance that may incur a color change by reacting to acidity (pH), a concentration of a specific substance, whether there is specific gas or a liquid element, etc., and whether an object substance exists may be detected by a color change of a sensor which is generated by attaching the above substance to paper, cotton, etc.

The sensor using the indicator dye does not require a power, and has high selectivity and sensitivity because a sensing through a chemical action is performed, and with the sensor, it is easy to manufacture the array for analyzing various object substances at the same time.

However, there are many weaknesses as follows in the existing sensor for detecting the object substance by a color change. Specifically, as the indicator dye is vulnerable to water, in order to protect the indicator dye from external moisture, it has been essential to apply an expensive membrane to which only the object substance gas can pass through. In addition, there has been a problem that as impurities adhere to the sensor while using the sensor, it is difficult to secure a reproducibility in a successive measurement.

### DETAILED DESCRIPTION

### Technical Problem

The disclosure is to solve the problems described above and the purpose of the disclosure is to provide a sensor for measuring a concentration of an object substance by a color change, which is manufactured to be resistant to water, a sensing system including the same and a manufacturing method of the sensor.

### Technical Solution

According to an embodiment of the disclosure, there is provided a sensor for measuring a concentration of an object substance by a color change, the sensor including a pad that is dried after being immersed in a solution containing an ionic substance consisting of an ionized indicator dye and ‘an ion having an opposite polarity to the ionized indicator dye between a cation and an anion constituting ionic liquid’; and a support member to which the pad is attached.

The pad in the support member may be disposed for directly contacting washing water.

The ionized indicator dye may be generated by ionizing at least one of chlorophenol red, bromocresol green, bromophenol blue, bromothymol blue, cresol red, methyl orange, methyl red, phenol red, phenolphthalein or thymol blue.

The ionic liquid may be selected from at least one of imidazolium salt, phosphonium salt, pyrrolidinium salt, piperidinium salt, fluoroborate salt, fluorophosphates salt, bis(fluorosulfonyl)imide salt or bis(fluorosufonyl)amide salt.

The pad may consist of at least one of fiber, ceramic, paper or polymer.

An adhesive substance may be applied to one side of the support member.

The sensor may further include a light receiver disposed between the pad and the support member for receiving light and a processor configured to determine a concentration of an object substance corresponding to a color of the pad based on light incident on the light receiver.

The sensor may further include a light source for irradiating light to the pad.

The sensor may further include a communicator, and the processor controls the communicator to transmit sensing data corresponding to a color of the pad to another electronic apparatus.

According to an embodiment of the disclosure, a sensing system includes a sensor including a pad dried after being immersed in a solution containing an ionic substance consisting of an ionized indicator dye and ‘an ion having an opposite polarity to the ionized indicator dye between a cation and an anion constituting ionic liquid’, and configured to transmit sensing data corresponding to a color of the pad to an external apparatus, and an electronic apparatus configured to receive sensing data from the sensor and perform an operation corresponding to the received sensing data.

The electronic apparatus may include a display displaying information on a concentration of a substance sensed in the sensor based on the received sensing data.

The display may display at least one of air pollution information, noxious gas information, water pollution information, disease diagnosis information, food state information or disaster state notification information, according to a concentration of a substance sensed by the sensor, based on the sensing data.

The sensor may be disposed to be adjacent to a filter for filtering a pollutant, and the electronic apparatus may display information on a degree of pollution of the filter based on the sensing data through the display.

The electronic apparatus may be a smart phone, a wearable device, a refrigerator, a washing machine, a cleaner, an air cleaner, an air conditioner, or a humidifier.

According to an embodiment, there is provided a method for manufacturing a sensor including a pad of which color changes according to a concentration of an object substance, the method including preparing an aqueous solution in which an indicator dye is ionized, adding ionic liquid to the aqueous solution, adding a non-polar solvent to the aqueous solution to which ionic liquid is added and stirring the aqueous solution, obtaining a solution containing the non-polar solvent and a substance dissolved in the non-polar solvent, and drying a pad after immersing the pad in the obtained solution.

In this case, the preparing the aqueous solution may include dissolving an indicator dye compound in a basic aqueous solution.

The preparing the aqueous solution may include dissolving salt of an indicator dye compound in water.

The indicator dye compound may be selected from at least one of chlorophenol red, bromocresol green, bromophenol blue, bromothymol blue, cresol red, methyl orange, methyl red, phenol red, phenolphthalein or thymol blue.

The ionic liquid may be selected from at least one of imidazolium salt, phosphonium salt, pyrrolidinium salt, piperidinium salt, fluoroborate salt, fluorophosphates salt, bis(fluorosulfonyl)imide salt or bis(fluorosufonyl)amide salt.

The obtaining the liquid may include removing a supernatant after the stirring operation.

### BRIEF DESCRIPTION OF THE DRAWINGS

FIG. 1 is a flowchart illustrating a method for manufacturing a composition according to an embodiment of the disclosure;

FIG. 2 is a view illustrating a method for manufacturing a pad according to an embodiment of the disclosure;

FIG. 3 to FIG. 6 are views illustrating a result of an experiment regarding a pad manufactured according to various embodiments of the disclosure;

FIG. 7 to FIG. 11 are views illustrating a sensor according to various embodiments of the disclosure;

FIG. 12 is a view for illustrating an application example of a sensor according to an embodiment of the disclosure;

FIG. 13 to FIG. 15B are views illustrating various embodiments regarding a method for providing a sensing result in a sensor;

FIG. 16 is a view illustrating an application example of a composition according to an embodiment of the disclosure; and

FIG. 17 is a view illustrating an application example of a sensor according to another embodiment of the disclosure.

### BEST MODE

Various modifications may be made to the embodiments of the disclosure, and there may be various types of embodiments. Accordingly, specific embodiments will be illustrated with drawings, and the embodiments will be described in detail in the detailed description. However, it should be noted that the various embodiments are not for limiting the scope of the disclosure to a specific embodiment, but they should be interpreted to include all modifications, equivalents or alternatives of the embodiments included in the ideas and the technical scopes disclosed herein. Meanwhile, in case it is determined that in describing the embodiments, detailed explanation of related known technologies may unnecessarily confuse the gist of the disclosure, the detailed explanation will be omitted.

Terms used in the disclosure are for illustrating a specific embodiment and not for limiting the scope of rights. Singular expressions may be interpreted to include plural expressions, unless defined obviously differently in the context. In this specification, terms such as ‘include’ and ‘consist of’ should be construed as designating that there are such characteristics, numbers, steps, operations, elements, components or a combination thereof in the specification, but not as excluding in advance the existence or possibility of adding one or more of other characteristics, numbers, steps, operations, elements, components or a combination thereof.

Hereinafter embodiments will be described in detail with reference to accompanying drawings.

The composition of which color is changed when the composition reacts to an object substance according to an embodiment may be applied to various fields for measuring a concentration of the object substance by a color change. For example, the composition may be used in an environment management field, a safety management field, a medical diagnosis field, a food management field, etc.

In a specific example, gas generated in the process of fermentation, decomposition, ripening of food may be an object of detection. For example, ammonia, acetic acid, aldehyde, sulfur compounds, alcohol, hydrogen sulfide, trimethylamne, ethylene, carbon dioxide, etc. may be the object of detection. In addition, bacteria and viruses may be the object of detection. In another example, the substance harmful to human body such as formaldehyde, toluene, etc. for determining air quality may be the object of detection for determining air quality, and hydrogen sulfide may be the object of detection for determining bad smell or bad breath.

In another example, alcohol may be the object gas of detection for a sobriety test, and the gas released from human body when diabetes, heart disease, lung disease, etc. are developed may be the object of detection for diagnosing the corresponding illnesses.

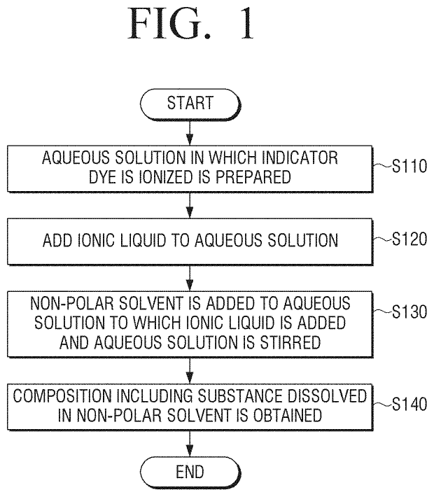

In another example, in order to determine a pollution level of a washing machine or a process of washing, water for rinsing may be the object of detection. An appropriate indicator dye may be used for manufacturing the composition of the disclosure to correspond to the above described various objects of detection. The indicator dye means an element which has a characteristic that a color changes by a contact with a specific component in gas, liquid, or solid. FIG. 1 is a flowchart illustrating a method for manufacturing the composition of which color changes when reacting to an object substance according to an embodiment of the disclosure.

Referring to FIG. 1, first, aqueous solution in which an indicator dye is ionized is prepared in operation S110.

Specifically, an indicator dye compound and water are prepared. The example of the indicator dye compound may be chlorophenol red, bromocresol green, bromophenol blue, bromothymol blue, cresol red, methyl orange, methyl red, phenol red, phenolphthalein, thymol blue, m-cresol purple, etc. These are the substances of which color is changed according to the change of pH, whether a specific substance is included, a case in which a specific substance is contained greater than a specific concentration, etc. However, the indicator dye compound used in the embodiment is not limited thereto.

Then, the indicator dye compound described above is dissolved in water. The indicator dye compound may be acidic or basic. If an acid indicator dye compound is put into acid solution, the hydrogen attached to the indicator dye compound does not easily come off. This is because there already is a large amount of hydrogen ion in the solution. However, if a basic substance is put into this solution, the concentration of hydrogen icon reduces and thus the hydrogens attached to the indicator dye compound are dissociated, and accordingly, the ionization may be easily performed. By using this feature, the solubility of the indicator dye compound may increase by adjusting the degree of acidic/basic of water. In a specific example, the indicator dye compound may be dissolved using about 0.1M of NaOH aqueous solution.

Meanwhile, it is possible to use salt of the indicator dye compound described above. For example, chlorophenol red sodium salt, bromocresol green sodium salt, bromophenol blue sodium salt, bromothymol blue sodium salt, cresol red sodium salt, methyl red sodium salt, phenol red sodium salt, thymol blue sodium salt, etc. may be dissolved in water.

As described above, the aqueous solution in which the indicator dye compound or salt of the indicator dye compound is dissolved includes an ionized indicator dye. In the case of the indicator dye compounds raised as an example above, the ionized indicator dye is in an anionic form.

In addition, the ionic liquid is added to the aqueous solution in which the ionized indicator dye is included in operation S120.

The ionic liquids are substances which do not form a crystal due to the asymmetry of the size of the cation and anion and exist in a liquid form in a broad temperature scope. Salt which is liquid in a room temperature is normally called the ionic liquid.

The ionic liquid may be manufactured by synthesizing various types of cations and various types of anions and the type of the ionic liquid used in the disclosure is not specially limited.

The representative cation of the ionic liquid may be imidazolium, phosphonium, ammonium, pyrrolidinium, piperidinium, etc. and representative anion may be bis(fluorosulfonyl)imide, bis(fluorosufonyl)amide, fluoroborate, fluorophosphates, etc.

In the disclosure, they are not limited to the above, but the ionic liquid selected from imidazolium based salt, phosphonium based salt, pyrrolidinium based salt, fluoroborate based salt, bis(fluorosulfonyl)imide based salt, and bis(fluorosufonyl)amide based salt may be used.

If the ionic liquid is added, in the aqueous solution, the ionized indicator dye and the ionic liquid are combined. For example, the ionized indicator dye in an anionic form and the cation of the ionic liquid are combined. The combination here is according to an electrostatic gravitation. If the ionized indicator dye is in a cation form, the ionized indicator dye may be combined with the anion of the ionic liquid.

This combined form is lipophilic, and thus, may be separated from the remaining part which is hydrophilic in the aqueous solution. For this operation, a non-polar solvent is added to the aqueous solution to which the ionic liquid is added, and the aqueous solution is stirred in operation S130.

The form which is a combination of the ionized indicator dye and the ion having the opposite polarity to the ionized indicator dye from among the ions in the ionic liquid is lipophilic and easily dissolved in the non-polar solvent, and thus, the above combination formation may be included in the non-polar solvent and divided from the hydrophilic part.

The non-polar solvent (or a hydrophilic solvent) which may be used in the above operation is not limited, but it is preferred that the boiling point is equal to or lower than 100° C. If the solvent of which boiling point is high is used, there is a disadvantage that the following drying stage takes long time. As an example of the non-polar solvent, dichloromethane, hexane, diethyl ether, etc. may be used.

Meanwhile, the operation of adding the non-polar solvent may be between operation S110 and operation S120.

In addition, the composition including the substance dissolved in the non-polar solvent is obtained in operation S140. The composition including the substance dissolved in the non-polar solvent may be a solution including the non-polar solvent and the substances dissolved in the non-polar solvent.

Specifically, as in the above, a phase separation of the lipophilic part and the hydrophilic part corresponding to the non-polar solvent occurs as described above, and the hydrophilic part of which density is low takes a supernatant. By removing the supernatant, the lipophilic solution including the ionic substance in which the ionized indicator dye is combined with the ion composing ionic liquid may be obtained. In this case, in order to remove the remaining hydrophilic substances, a washing operation using a polar solvent or water may be additionally performed for several times.

The obtained lipophilic solution may be used as a composition of the disclosure without an additional processing. Alternatively, additional processing may be performed to correspond to the purpose of the usage environment. For example, the composition in the disclosure may be manufactured as an ink, and in this case, additional substances which is required may be further included. For example, the composition may be manufactured in various forms such as an ink for a stamp, an ink for a pen, etc.

The purpose of the disclosure is to provide not only the above described manufacturing method but also the composition manufactured according to the above described manufacturing method.

The composition manufactured according to the above manufacturing method contains an ionic substance consisting of “an ionized indicator dye and ‘an ion having an opposite polarity to the ionized indicator dye between a cation and an anion constituting the ionic liquid.’”

Here, the ionized indicator dye means the indicator dye compound or the substance in which salt of the indicator dye compound is ionized, and may be in a form of a cation or an anion when being ionized, according to the type of the used indicator dye compound or the used salt of the indicator dye compound.

If the ionized indicator dye is a cation, the indicator dye is combined with an anion of an ionic substance to form an ionic substance, and if the ionized indicator dye is an anion, the indicator dye is combined with a cation of the ionic substance to form an ionic substance. Here, the ionic substance means the state in which a cation and an anion are combined by an electrostatic gravitation.

Any one of the cation and the anion constituting the ionic substance included in the composition of the disclosure is derived from an indicator dye compound, and another one is derived from ionic liquid. Accordingly, the ionic substance is a new substance different from the used indicator dye compound and the ionic liquid.

The ionized form of the indicator dye compound generally used is in the form of an anion, and generally used ionic liquid consists of a large cation and a small anion, and the ionic substance included in the composition in the disclosure includes the large cation of the ionic liquid, and thus, the ionic substance has low lattice energy, and accordingly, may exist in a form of liquid in a room temperature.

The ionized indicator dye constituting the ionic substance contained in the composition in the disclosure may be formed by dissolving the following indicator dye compounds in water.

For example, the ionized indicator dye may be formed as at least one of the indicator dye compounds such as chlorophenol red, bromocresol green, bromophenol blue, bromothymol blue, cresol red, methyl orange, methyl red, phenol red, phenolphthalein, thymol blue, etc. is dissolved in water. However, it is not limited to the above examples.

Alternatively, the ionized indicator dye may be formed as the salt of the following indicator dye compounds is dissolved in water.

For example, the ionized indicator dye may be formed as at least one of the indicator dye compounds such as chlorophenol red sodium salt, bromocresol green sodium salt, bromophenol blue sodium salt, bromothymol blue sodium salt, cresol red sodium salt, methyl red sodium salt, phenol red sodium salt, thymol blue sodium salt, etc. is dissolved in water. However, it is not limited to the above examples.

A cation or an anion of the ionic liquid constituting an ionic substance contained in the composition in the disclosure may be derived from the following ionic liquids.

For example, the ionic liquid may be selected from at least one of imidazolium based salt, phosphonium based salt, pyrrolidinium based salt, piperidinium based salt, fluoroborate based salt, fluorophosphates based salt, bis(fluorosulfonyl)imide based salt, and bis(fluorosufonyl)amide based salt, but it is not limited thereto.

The composition according to the disclosure may be changed into the color corresponding to the concentration of the object substance when reacting to the object substance.

If an ink or a paint is manufactured with the composition according to the disclosure, the composition may be applied to anywhere a user wants. The compound is lipophilic, and thus, resistant to water.

Another purpose of the disclosure is to provide a sensor for measuring the concentration of an object substance using the obtained composition as described above.

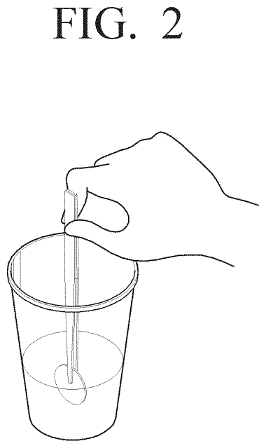

Specifically, a pad may be manufactured by immersing the pad into the solution containing a substance dissolved in a non-polar solvent and the non-polar solvent, which is obtained through the method illustrated in FIG. 1, as illustrated in FIG. 2, and by drying the pad. In addition to the method of immersing a pad, it is possible to drop a little amount of the solution containing the above described composition on the pad and dry the pad. In operation S130 illustrated in FIG. 1 above, if the non-polar solvent of which boiling point is equal to or lower than 100° C. is used, the drying time of the pad may be reduced. After the drying operation, the pad itself may be used as a sensor or the pad may be attached to an appropriate support member and used as a sensor.

A detailed embodiment regarding the pad manufacture describe above will be described below.

Embodiment for Manufacturing a Pad

For manufacturing a composition, chlorophenol red is used as an indicator dye compound. The chlorophenol red has a propertiy of changing from pH 4.8 (violet) to pH 6.7 (yellow). The molecular weight is 423.27 g/mol and the chemical structure is as the following chemical formula 1.

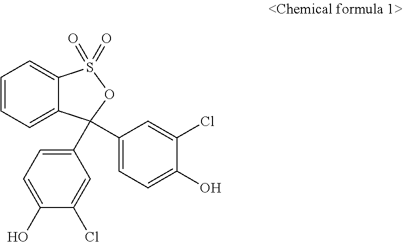 [SMILES: O=S1(=O)OC(c2ccc(O)c(Cl)c2)(c2ccc(O)c(Cl)c2)c2ccccc21]

As an ionic liquid, P₆₆₆14Cl(Trihexyl-(tetradecyl)phosphonium chloride) is used. The molecular weight is 519.31 g/mol, and the chemical structure is as the following chemical formula 2.

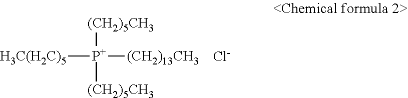

As a non-polar solvent, dichloromethane is used. The molecular weight is 84.93 g/mol, and the chemical structure is as the following chemical formula 3.

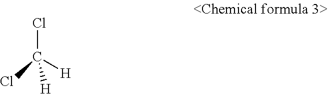

As a pad, paper and cotton fabric are used.

Then, for manufacturing the pad, an operation is proceeded in the following order.

First, the chlorophenol red is put into water and 0.1M of sodium hydroxide (NaOH) is added thereto. Then, P₆₆₆₁₄Cl is added so that a final concentration of the chlorophenol red in the solution is 2.3 mM.

After then, the dichloromethane is added. Thereafter, the solution to which the dichloromethane is added is stirred. The stirring operation may be omitted.

After the stirring operation, supernatant, that is, a water layer is removed. In this case, a washing process of adding the same amount of water as the added water is performed. The washing process may be omitted.

After removing the water layer as described above, 640 of the remaining solution is taken, dropped to Chromatography paper and EMPA 108, respectively, and dried.

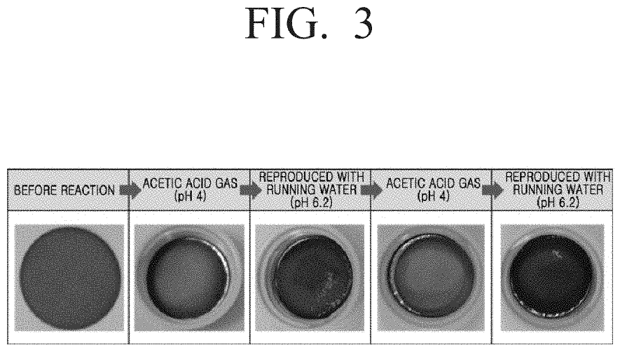

The result of the experiment of the reusability of the paper pad obtained through the above embodiment is illustrated in FIG. 3.

FIG. 3 illustrates the result of exposing the manufactured paper pad to acetic acid gas (pH 4), washing the pad with running water (pH 6.2), exposing the pad to the acetic acid gas (pH 4) again, and washing the pad with running water (pH 6.2) again. As shown in the result illustrated in FIG. 3, when the pad is exposed to the acetic acid gas and reproduced with running water, the pad shows the same color (a third drawing) as the color before the reaction (a first drawing), and when the pad is exposed to the acetic acid gas again (a fourth drawing), the pad shows the same color as the color of the pad exposed to the acetic acid gas first (a second drawing), and when the pad is reproduced with running water again, the pad shows the same color as the color of the pad before the reaction (a fifth drawing). That is, even if the paper pad manufactured according to an embodiment is washed by water, the color change function does not decline and the paper pad may be reused.

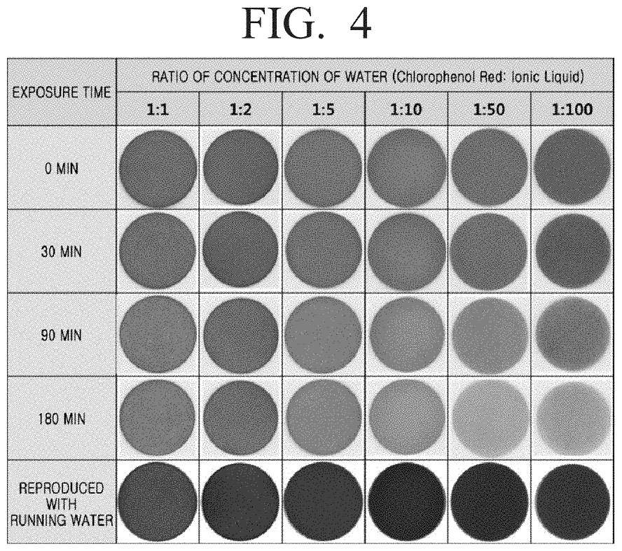

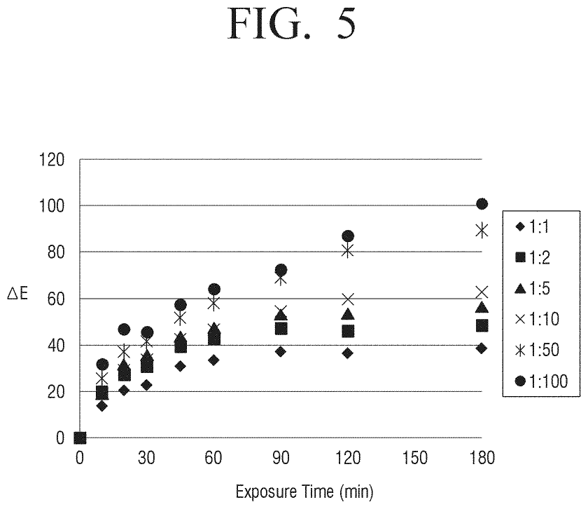

FIG. 4 is a result of that a plurality of paper pads are manufactured by differentiating the usage ratio of the chlorophenol red which is an indicator compound and P₆₆₆₁₄Cl which is ionic liquid and then the paper pads are exposed to the acetic acid gas (pH 4).

Referring to FIG. 4, the higher the usage ratio of the ionic liquid, the better the color development. FIG. 5 is a view in which the color change is digitalized and shown as a graph. As certainly illustrated in FIG. 5, the higher the ratio of ionic liquid in a pad, the more the color change thereof as time passes.

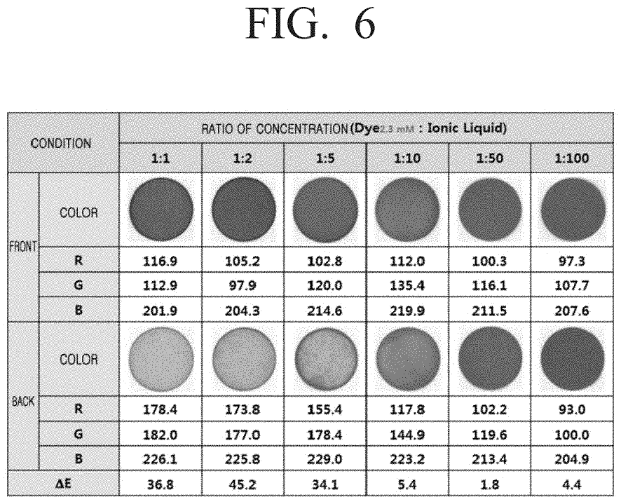

FIG. 6 illustrates that a plurality of paper pads are manufactured by differentiating the usage ratio of the chlorophenol red which is an indicator compound and P₆₆₆₁₄Cl which is ionic liquid and then the colors of the front and back sides of the paper pad are compared. The side to which a solution is dropped is a front side and the opposite side is a back side.

Referring to FIG. 6, it is shown that the higher the usage ratio of the ionic liquid, the better the coating of composition up to the back side.

Based on the results shown in FIG. 4 to FIG. 6, as the usage ratio of the ionic liquid increases when manufacturing a pad, the pad of which color feature is great may be obtained.

The pad manufactured as described above may be used as a sensor for performing a detection by a color change.

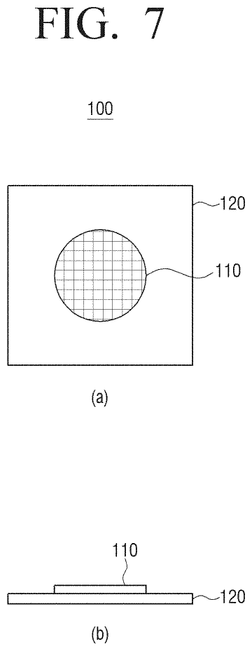

FIG. 7 is a view illustrating a sensor for detecting an object substance by a color change according to an embodiment.

Referring to FIG. 7, the sensor 100 includes a pad 110 and a support member 120. (a) of FIG. 7 is a view of the sensor 100 seen from above, and (b) of FIG. 7 is a view of the sensor 100 seen from side.

The pad 110 may be generated by being immersed in the solution containing the composition manufactured according to the above described manufacturing method and being dried, or generated by dropping the solution on the pad 110 and being dried.

Accordingly, the pad 110 contains an ionic substance consisting of “an ionized indicator dye and ‘an ion having an opposite polarity to the ionized indicator dye between a cation and an anion constituting the ionic liquid.’”

Meanwhile, the pad 110 may consist of at least one of paper, porosity fiber or porosity ceramic.

The support member 120 may be anything that can fix the pad 110. For example, the support member 120 may be manufactured with a film, paper, etc. In addition, the support member 120 may consist of a polymer and as examples of the usable polymer, there are a hydrophobic polymer selected from among poly vinil chloride (PVC), poly methyl methacrylate (PMMA), poly tetrafluoroethylene (PTEE), polystyrene (PS), etc., and a hydrophilic polymer selected from among polysaccharide (cellulose), polyacrylate, polyacrylamide, polyimine, polyglycol, hydrogel, etc.

According to an embodiment, the back side of the support member 120 may include an adhesive substance or a tape for fixing. In this case, the sensor 100 may be used as a sticker. Accordingly, the sensor may be attached to various places such as glass, wallpaper, furniture, toys, home appliances, windows, etc. and used.

Especially, the composition included in the pad 110 is lipophilic and thus, it does not melt even being contacted water, and thus, an additional structure for protecting the pad 110 from water is not required. Accordingly, the pad 110 may be disposed on the support member 120 so as to directly contact water. That is, as illustrated in FIG. 7, the form in which the pad 110 is completely exposed may be used as it is as a sensor. Accordingly, the sensor 100 may be reused by being washed by water after being used. In addition, if the sensor 100 is placed in clean air for a predetermined time, the gas substance attached to the pad 110 spreads to air and is removed, and thus, the pad is reusable.

Meanwhile, the support member 120 is not an essential element and the sensor may be composed only by the pad 110 itself. Also, the pad 110 is merely a measure to fix the composition according to the disclosure and it is possible that the composition itself is applied to the support member 120 without the pad.

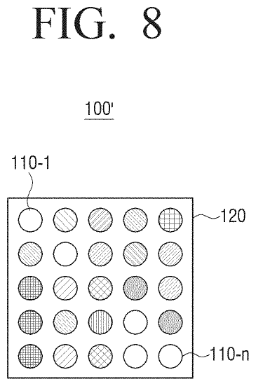

FIG. 8 is a view illustrating a sensor 110′ according to another embodiment of the disclosure.

Referring to FIG. 8, in the sensor 110′, an array of a plurality of pads 110-1 to 110-n and the plurality of pads 110-1 to 110-n may be disposed at the support member 120.

The plurality of pads 110-1 to 110-n may be for different object substances. Accordingly, each of the plurality of pads 110-1 to 110-n may be manufactured using different indicator dye compounds to correspond to the object substance to be detected.

Accordingly, if a plurality of pad arrays are used as illustrated in FIG. 8, many substances may be detected at a time.

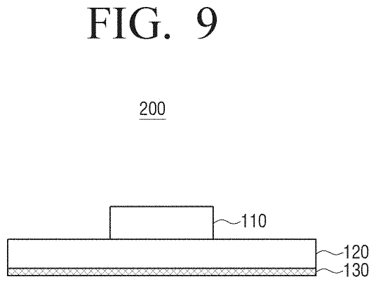

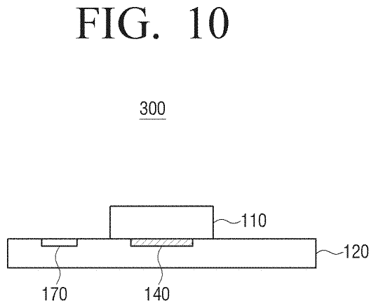

FIG. 9 is a view illustrating a sensor according to another embodiment.

Referring to FIG. 9, the sensor 200 is manufactured in a form of a sticker.

Specifically, the sensor 200 includes the pad 110, the support member 120, and an adhesive substance 130.

The adhesive substance 130 may be applied to a back side of the support member 120. The types of the applied adhesive substance 130 may be a permanent adhesive and a removable adhesive.

If the sensor 200 described above is used, the sensor 200 may be attached to anywhere a user wants and used.

FIG. 10 is a view illustrating a sensor according to another embodiment of the disclosure.

Referring to FIG. 10, the sensor 300 includes the pad 110, the support member 120, a light receiver 140, and a processor 170.

The light receiver 140 is an element which may generate a photoelectric current corresponding to an amount of light by receiving the light, and may be disposed between the pad 110 and the support member 120.

Specifically, the light receiver 140 includes a plurality of photodiodes and different color filters may be disposed at the upper part of each of the plurality of photodiodes. For example, a red filter may be disposed at a first photodiode, a green filter may be disposed at a second photodiode, and a blue filter may be disposed at a third photodiode. Accordingly, the light incident on the light receiver 140 may be filtered by each filter and incident on the photodiode, the first photodiode receives light of a red wavelength, the second photodiode receives light of a green wavelength, and the third photodiode receives light of a blue wavelength.

Meanwhile, an element such as a photo conductive cell, photo transistor, etc. may be used in addition to the photodiode.

The processor 170 included in the sensor 300 is a configuration for controlling an overall operation of the sensor 300.

According to an embodiment, the processor 170 may include at least one of CPU (or DSP, MPU, etc.), RAM, ROM, and system bus. The processor 170 may be implemented as a microcomputer (MICOM), application specific integrated circuit (ASIC), etc.

The processor 170 may detect the color of the pad 110 by analyzing data obtained by performing A/D conversion of the light received from the light receiver 150. Specifically, the processor 170 may calculate red-green-blue (RGB) value corresponding to the light of a red wavelength received by the first photodiode, the light of a green wavelength received by the second photodiode, and the light of a blue wavelength received by the third photodiode, described above.

The processor 170 may determine at least one of a type and a concentration of an object substance corresponding to the detected color when the color of the pad 110 is detected. Specifically, a storage (not illustrated) of the sensor 300 may store information on a table defining the correlation of the color value and concentration, and the type of the indicator dye included in the pad 110, and the processor 170 may determine at least one of the type or concentration of the object substance based on the information. Alternatively, sensing data corresponding to the color of the pad 110 may be transmitted to an external electronic apparatus storing the above information and the type, concentration, etc. of the substance corresponding to the sensing data may be determined in the external electronic apparatus.

The storage included in the sensor 300 may be implemented as a non-volatile memory, a volatile memory, a flash-memory, a hard disk drive (HDD), a solid state drive (SSD), etc. Meanwhile, the storage may be implemented as an external storage medium, for example, a micro SD card, a USB memory, and an external server, in addition to the storage medium in the sensor 300.

Meanwhile, the sensor 300 may further include a communicator (not illustrated) for communicating with another electronic apparatus.

The communicator included in the sensor 300 may access an external apparatus not only through a local area network (LAN) and an internet network but also by a wireless communication method (e.g., wireless communications such as Z-wave, 4LoWPAN, RFID, long term evolution (LTE) D2D, BLE, GPRS, Weightless, Edge Zigbee, ANT+, NFC, IrDA, DECT, WLAN, Bluetooth, Wi-Fi, Wi-Fi Direct, GSM, UMTS, LTE, WiBRO, etc.). The communicator may include various communication chips such as a Wi-Fi chip, a Bluetooth chip, a wireless communication chip, etc.

The sensor 300 may communicate with various communication apparatuses through the communicator. For a specific example, the processor 170 may control the communicator to transmit at least one of sensing data corresponding to a color of the pad 110, information on an indicator dye contained in the pad 110, information on the type of an object substance determined based on the color of the pad 110, information on the concentration of the object substance determined based on the color of the pad 110, to at least one another electronic apparatus through the communicator. In this case, the electronic apparatus may be a TV, a smartphone, a tablet, a smart watch, etc.

The electronic apparatus may provide various types of information to a user based on the information received from the sensor 300, and for example, the UI screen including the information on the object substance measured in the sensor 300 on the display of the electronic apparatus.

For example, the sensor 300 may be included in an air conditioner, an air cleaner, and the like, and may transmit the sensing data corresponding to a color change of the pad 110 to an electronic apparatus through the communicator, and the electronic apparatus that receives the sensing data may display the UI screen including information on the filter pollution degree, etc. of an air conditioner, an air cleaner, etc. based on the received sensing data.

For another example, the sensor 300 may transmit the sensing data corresponding to the color of the pad 110 according to the concentration of CO₂ to an electronic apparatus such as an air conditioner through a communicator, and the air conditioner may control the temperature of the air conditioner based on the received sensing data. The high concentration of CO₂ means the high population density, and thus, the air conditioner may lower the temperature if it is determined that the concentration of CO₂ has grown based on the received sensing data.

According to another data, the sensor 300 above may be disposed at each space of an apartment, a building or the like, and transmit the sensing result to the server of a janitor's office. Accordingly, the sensor according to the disclosure may be used to detect the substance generated in a disaster status such as the status in which there is smell of burning wire in case of fire, and thus, the janitor's office may receive a notification regarding the place where a danger (e.g., fire, air pollution) has occurred in the apartment or the building.

In addition, the sensor of the disclosure may measure the air quality of the space in which a user is located, by being attached or embedded in a wearable apparatus which is always carried by a user, for example, a strap of a smart watch, a band, an accessary of a smartphone, etc., and transmit the result of the measurement to a user terminal apparatus.

Meanwhile, the sensor 300 may further include a display for displaying the sensing result to a user.

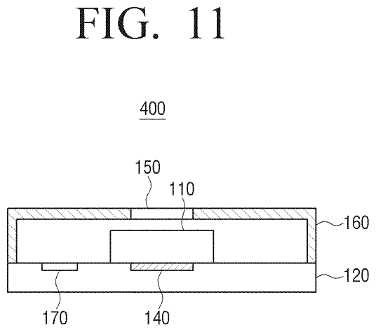

FIG. 11 illustrates a form that a light source is additionally added to the sensor 300 illustrated in FIG. 10.

The light source 150 is a configuration for irradiating light to the pad 110, and may be composed of a white light emitting diode (LED).

The light generated from the light source 150 may be irradiated to the pad 110, and the light reflected from the pad 110 may be incident on the light receiver 140. The light source 150 allows the color of the pad 110 to be detected well even in a dark condition.

In this case, the processor 170 of the sensor 400 may control the light source 150 only when the color detection of the pad 110 is required so as to generate light.

The light source 150 may be disposed at the upper part of the pad 110 as illustrated in FIG. 11, but it is not limited to this location, and may be disposed at an appropriate location by considering the location of the pad 110.

Meanwhile, in FIG. 11, the light source 150 is disposed at the structure 160, and the structure may function not only as a supporter of the light source 150 but also as a protector of the pad 110. The pad 110 should contact an object of detection, and thus, the structure 160 may be in a form in which the pad 110 is not entirely covered. Alternatively, the structure 160 may be formed with the substance which may cover the pad but may be passed through by the object of detection.

Meanwhile, according to an embodiment of the disclosure, there is provided a sensing system including the sensor described above and an electronic apparatus communicating with the sensor.

Specifically, the sensing system includes a pad immersed in the solution containing an ionic substance consisting of “an ionized indicator dye and ‘an ion having an opposite polarity to the ionized indicator dye between a cation and an anion constituting the ionic liquid,’” and includes a sensor transmitting the sensing data corresponding to the color of the pad to an external electronic apparatus through the communicator of the sensor, and an electronic apparatus receiving the sensing data from the sensor and performing an operation corresponding to the received sensing data.

In this case, the electronic apparatus may receive sensing data from the sensor through the communicator included in the electronic apparatus, analyze the received sensing data and determine at least one of a type and concentration of the object substance sensed in the sensor. Alternatively, it is possible that the sensor itself determines the type, concentration, etc. of the sensed object substance and transmits the determination result to an electronic apparatus.

The electronic apparatus may perform the operation corresponding to at least one of the type or concentration of the object substance sensed in the sensor.

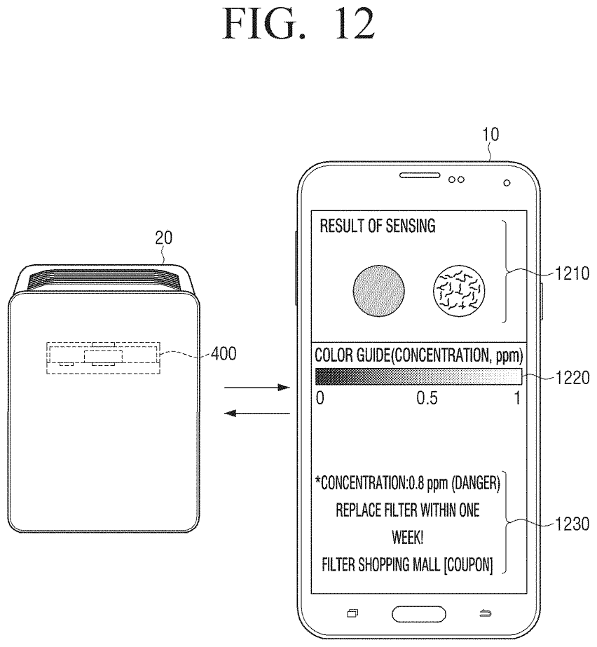

Meanwhile, the electronic apparatus in the sensing system may include a display displaying information on the type, concentration, etc. sensed in the sensor. The electronic apparatus may display at least one of the type of the above object substance, air pollution information according to the concentration, noxious gas information, water pollution information, disease diagnosis information, food state information, and disaster state notification information. However, it is not limited to these examples, and the electronic apparatus may provide other information predictable from the information that can be measured by a sensor. The sensing data received from the sensor may be used in various ways according to the location where the sensor is disposed, and the type of the electronic apparatus. For example, the sensor may be disposed by being adjacent to the filter filtering pollutant, and if the electronic apparatus includes a display, the electronic apparatus may display information on the pollution level of the filter through the display based on the sensing data received from the sensor. FIG. 12 is an example of the sensing system.

Referring to FIG. 12, the sensor 400 may be disposed inside the air conditioner 20. The sensor 400 having the light source 150 is appropriate because the sensor is disposed inside the product where is lightproof, but according to cases, the sensor 300 of FIG. 10 without a light source may be used.

Specifically, the sensor 400 may sense the substance contaminating the filter by being mounted at the entrance of the air conditioner 20. In addition, the sensor 400 may transmit the sensing data to the electronic apparatus 10 including the display through the communicator of the sensor 400.

The electronic apparatus 10 may display the sensing result by analyzing received sensing data. Specifically, a UI screen including an image corresponding to the pad 110 of the sensor 400, an area 1210 indicating the image of the object of detection, a color guide 1220 which may confirm the concentration corresponding to the color of the pad 110, and an area 1230 indicating the concentration and additional information of the object of detection may be displayed on the electronic apparatus 10. As illustrated in FIG. 12, the UI filter displayed on the electronic apparatus 10 includes a notification of a filter replacement time and a user may move to the website in which the user may buy the filter through the UI. In addition, a UI which may be displayed in the electronic apparatus 10 may include a guide of an action that should be performed by a user. For example, the guide regarding ventilation, cleaning apparatus, etc. may be included in the UI. The sensor 400 may be disposed not only in the air conditioner 20, but also in the product of which pollution degree or air quality in the product is required to be determined, such as an air conditioner, a cleaner, etc. In addition, the sensor 400 may transmit the sensing data corresponding to the color of the pad 110 to the electronic apparatus 10 through the communicator of the sensor 400, and the electronic apparatus 10 may display disaster state notification information etc. related to air pollution information, noxious gas information, and fire gas. According to another embodiment, the operation of the air conditioner 20 may be automatically controlled according to the sensing result of the sensor 400. For example, the air conditioner 20 includes a filter and a communicator for communicating with a pan controlling external air in the filter and with the sensor 400, and if the sensing result is received from the sensor 400, the speed of a pan or a driving time of a pan may be controlled by determining the concentration of the pollutant in the air based on the received sensing result. Meanwhile, the air conditioner 20 and the sensor 400 may be implemented as separated apparatuses or as a single apparatus according to cases.

According to another embodiment, the sensor 400 may control the operation of the robot cleaner (not illustrated). For example, the sensor 400 may be disposed at the robot cleaner and notify a user if a substance (e.g., an excreta of a puppy) which is undesirable to the robot cleaner to intake is detected. Specifically, the sensor 400 disposed at the robot cleaner may transmit sensing data to an external apparatus and the electronic apparatus may display a notification message based on the received sensing data through the display disposed at the electronic apparatus. Alternatively, the robot cleaner itself may include a display, and in this case, the notification message may be displayed through the display of the robot cleaner. In addition, the sensor 400 disposed at the robot cleaner may sense the peripheral substances of the robot cleaner, and if it is sensed that the substances such as an excreta of a puppy exists near the robot cleaner, the sensor 400 may control the robot cleaner not to move in that way.

In addition, the sensor 400 described above may be disposed at the location requiring a measurement of water pollution, for example, a swimming pool, and transmit the sensing data corresponding to the concentration of an object substance, and display the water pollution information in the electronic apparatus 10, and in addition, may display the information on the action required for resolving the water pollution, and the like. Alternatively, the sensor 400 may be implemented as a portable health management device for a user and detect user's bio-gas, etc. related to a specific disease, transmit the sensing data corresponding to the concentration of the detected gas to the electronic apparatus 10 and the electronic apparatus 10 may display the disease diagnosis information based on the received sensing data.

Meanwhile, it has been illustrated that the electronic apparatus 10 communicating with the sensor 400 is a smartphone, but in addition to the smartphone, the sensor 400 may communicate with various electronic apparatuses such as a wearable device, a refrigerator, a washing machine, a cleaner, an air cleaner, an air conditioner, a humidifier, etc. to perform a control operation according to the sensing result. However, the disclosure is not limited to the above apparatuses.

As illustrated in the above embodiments, the sensor in the disclosure may be used in managing various home appliances. Regardless of the purchase time of the home appliance, a status of the home appliance (e.g., a filter pollution degree) variously generated according to a user environment (e.g., degree of peripheral pollution), and a user's habit (e.g., using time or intensity) may be determined through the sensor of the disclosure, and thus, the home appliances may be managed more appropriately.

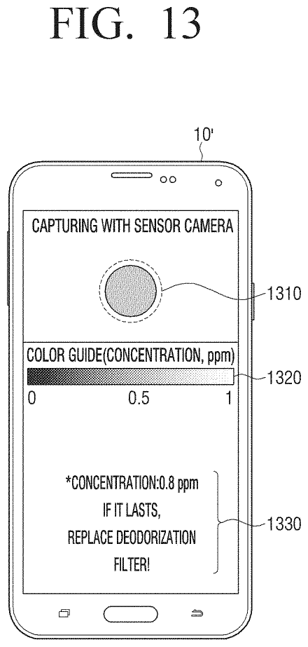

A user may confirm a pad of a sensor with naked eyes and confirm the concentration of the object of detection, but according to an embodiment, an electronic apparatus that may analyze the color of the pad of the sensor and provide information on the object of detection may be provided. FIG. 13 is a view illustrating this electronic apparatus.

Referring to FIG. 13, the electronic apparatus 10′ may be an apparatus such as a smartphone with a camera function.

The electronic apparatus 10′ may capture the pad of the sensor of the disclosure, identify the color of the pad and provide the concentration information corresponding to the color through the display of the electronic apparatus 10′.

Specifically, the electronic apparatus 10′ may display a UI screen including an area 1310 indicating the captured pad image, a color guide 1320 with which the concentration corresponding to the color of the pad 110, and an area 1330 indicating the concentration of the object of detection and additional information.

In this case, the electronic apparatus 10′ pre-stores a matching table regarding the color and the concentration of the pad, and thus, the above information may be provided.

Meanwhile, according to an embodiment, the electronic apparatus 10′ may analyze a plurality of pads of which contained ionized indicator dyes are different from each other. In this case, on the pad, an identification mark indicating the information of the indicator dye contained in the pad may be printed such as a QR code. When capturing the pad, the electronic apparatus 10′ may recognize the identification mark printed on the pad, grasp the indicator dye contained in the pad and determine the concentration corresponding to the color of the pad.

According to another embodiment, the electronic apparatus 10′ may provide appropriate information according to the environment in which the pad is attached. For example, as illustrated in FIG. 13, the electronic apparatus 10′ may recognize that the pad is attached to an air conditioner and provide the information related thereto.

For this operation, the electronic apparatus 10′ may provide a UI which allows a user to select where to capture a pad before capturing the pad. Alternatively, the identification mark included in the pad described above may include information on the places where the pad is attached. Accordingly, the electronic apparatus 10′ may identify the place where the pad is attached by capturing the identification mark. Alternatively, the communicator included in the sensor of the disclosure may support a local area communication such as an NFC and if the electronic apparatus 10′ approaches to capture the pad of the sensor, the sensor may transmit the information on the environment where the sensor is disposed to the electronic apparatus 10′ through the local area communication.

Meanwhile, the electronic apparatus 10′ may provide not only information on the concentration of the object of detection through the UI as described above but also provide the information with the augmented reality.

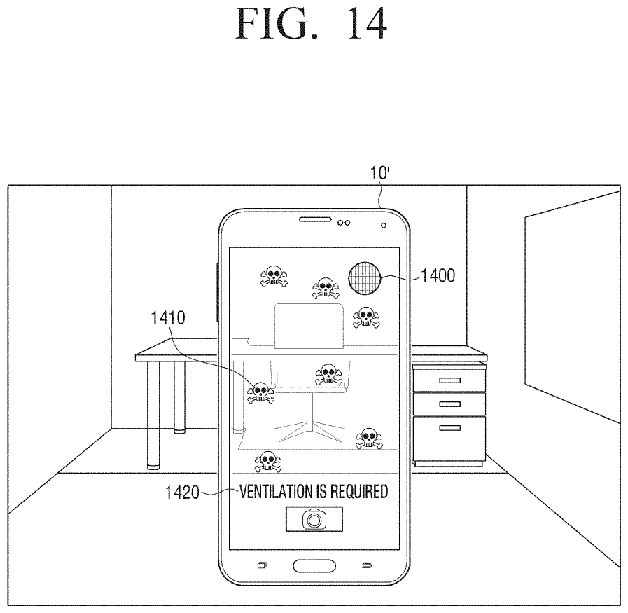

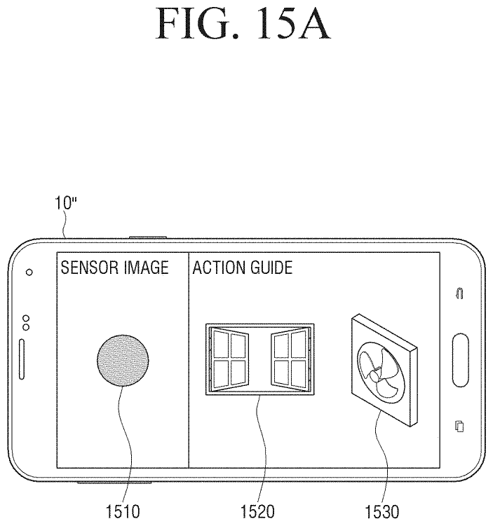

FIG. 14 is a view illustrating an information providing method through the augmented reality of the electronic apparatus 10′ according to an embodiment of the disclosure.

Referring to FIG. 14, the electronic apparatus 10′ may recognize a color by capturing the sensor 1400 for detecting the object substance with a color change which is attached at a room according to the disclosure, and based on the recognized color, the information on the type and concentration of the detected object with an augmented reality.

For example, the sensor 1400 may be a sensor indicating a color change in response to the gas harmful to human body, and the electronic apparatus 10′ may capture the sensor 1400 by driving a camera function, determine a type and concentration of the gas exists in the present space by analyzing the color of the sensor 1400, and display the UI element 1410 expressing the type and concentration of the gas as illustrated in FIG. 14. According to an example, the UI element 1410 may be displayed by an animation effect in which the UI element is floated as a gas molecule. Also, the electronic apparatus 10′ may also provide information 1420 on the action which should be performed by a user.

As illustrated in FIG. 14, the sensor of the disclosure may be disposed in a room or various places such as an office, a workplace, a store, a hotel, a hospital, a school, a car, and a front door for detecting various substances. For example, the sensor according to the disclosure may be used to detect volatile organic compounds such as xylene, formaldehyde (HCHO), ethylbenzene, benzene (C₆H₆), toluene (C₆H₅CH₃), acetone (C₃H₆O), cyclohexane, ethanol, and methanol. The substance such as xylene, formaldehyde, and ethylbenzene causes a Sick House Syndrome. In addition, the benzene is a harmful substance which may be generated when cooling a vehicle, cooking, from a single service package container, at a gas station (gasoline), etc. and may cause a leukemia, an anemia, etc. In addition, the methanol may cause a stimulus on eyes and respiratory organ, sleepiness, dizziness, a damage on a fetus or a reproductive ability, and a damage on a digestive system and a central nervous system.

Further, the sensor according to the disclosure may be used to detect the pollutant generated from an environment where fine dust, pollen, mold, bacteria, viruses and smoke (CO) exist. In addition, the sensor according to the disclosure may be used to detect the output according to the life habit such as nicotine, tobacco smoke (CO), dandruff, smoke (cook), carbon dioxide (CO2), etc.

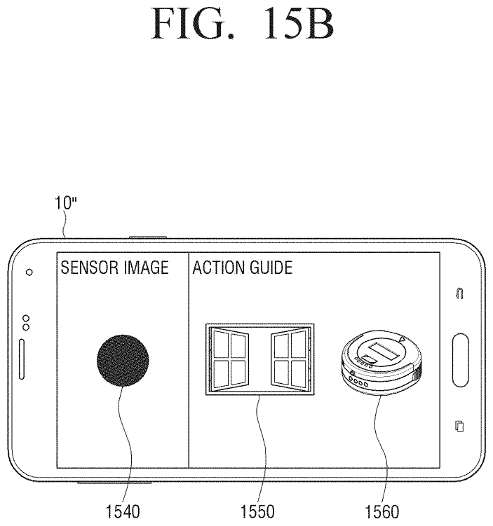

FIG. 15A to FIG. 15B are views for illustrating another example of a UI screen which may be displayed on the electronic apparatus communicating with the sensor of the disclosure.

The electronic apparatus 10′ may store pad color information corresponding to the sensing data of the sensor, and action guide information corresponding the sensing data of the sensor, and may display various UI screens based on the stored information.

Referring to FIG. 15A to FIG. 15B, the electronic apparatus 10′ may provide information on the action which should be performed by a user by each color of the pad of a sensor through the display.

Specifically, referring to FIG. 15A, the electronic apparatus 10′ may display the pad image 1510 of the sensor having the color corresponding to the sensing data based on the sensing data received from the sensor, and as guide information on the action to be performed according to the type or concentration of the object substance indicated by the sensing data, may display a window opening guide image 1520 and a ventilation guide image 1530.

If a pad color of the sensor is different, a different action guide may be provided. Referring to FIG. 15B, the electronic apparatus 10” may display a pad image 1540 of the sensor having the color corresponding to the sensing data and display a window opening guide image 1550 and a robot cleaner operation guide image 1560 as guide information on the action to be performed according to the type and concentration of the object substance indicated by the sensing data, based on the sensing data received from the sensor.

In the above embodiment, it has been illustrated that the action guide information is provided in a form of a still image, but it is possible to provide the action guide information in a form of a video, or with text information. According to an embodiment, the user may more easily understand which action the user should be perform in the environment detected by the sensor.

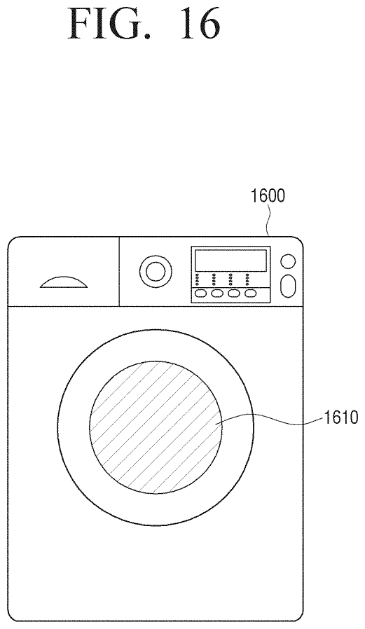

FIG. 16 is a view illustrating an application example of a composition of which color changes when reacting with an object substance.

Referring to FIG. 16, the washing machine 1600 may include a door 1610 to open and close the inlet of the washing machine.

The color change composition according to the disclosure may be coated on the area inside the door 1610 which directly contacts washing water (rinsing water). As described above, the composition of the disclosure is lipophilic, and thus, does not melt even if the composition directly contacts water.

The material of the door 1610 is transparent and the color change of the composition coated inside can be observed from an outside.

The coated composition may include the indicator dye for detecting the concentration of the detergent in washing water. Accordingly, through the color change of the coated composition, it may be grasped how much detergent is included in the current washing water. It is preferable to rinse until almost no detergent is included in the washing water, and thus, a user may grasp how many times the rinsing should be performed by confirming the color change of the coated composition.

According to an embodiment, the user may grasp the washing status through the color change of the door 1610, and thus, may determine the washing intensity, whether to put detergent, whether to wash, etc.

Meanwhile, the sensor 400 illustrated in FIG. 11 is disposed in the washing machine 1600 and monitor the pollution in the washing machine or pH of the number of rinsing operation, and transmit the monitoring result to the electronic apparatus such as a smart phone. In this case, the information notifying that the washing machine needs to be cleaned or the information on the progress status of the washing may be displayed in the electronic apparatus. Alternatively, the washing machine 1600 may automatically control the operation of the washing machine according to the sensing result of the sensor 400. For example, if the pH of the number of rinsing operation detected by the sensor 400 is equal to or greater than 8, the washing machine 1600 may control to additionally perform the rinsing operation.

In addition to the descriptions provided in the above regarding the number of rinsing operation, the sensor of the disclosure may measure the characteristic of water, that is, pH and hardness, and may be used to detect inorganic matter, organic matter, bacteria, and viruses (pathogens). In addition, the sensor of the disclosure may be used for water in various environments, for example, ground water, sewage, waste water, a fishbowl (purification process such as performed in an aquarium), a swimming pool (chemical treatment), etc.

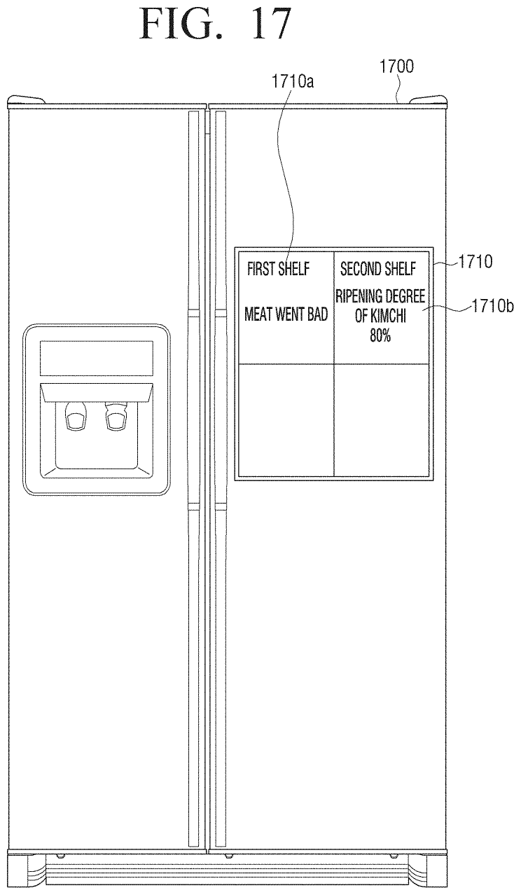

FIG. 17 is a view illustrating an application example of a sensor for measuring the concentration of the object substance by a color change according to another embodiment of the disclosure.

Referring to FIG. 17, the refrigerator 1700 may include the sensors illustrated in FIG. 10 or FIG. 11. Specifically, the sensors may be attached to each food container and the color thereof may change according to the gas generated from food. For example, each sensor may detect the gas generated when food goes bad or the gas generated when the food ferments. In addition, unique gas is generated for each food, and thus, the sensors may detect which food is in which food container. In addition, the sensors in the disclosure may change their color in response to the concentration of a mold, microorganism gas, etc., and through this, the freshness of the food may be recognized.

In addition, each sensor may provide the information on the food in the container, information on that the food does bad, information on the fermentation degree of the food, information on the freshness of food, etc. to the refrigerator 1700 through the communicator, and the display 1710 of the refrigerator 1700 may display such information. For example, as illustrated in FIG. 17, the information that the meat in the first shelf of the refrigerator 1700 went bad 1710a and information on that Kimchi in the second shelf is suitably fermented 1710b may be displayed through the display 1710. For another example, if it is determined that the freshness of food is low through a sensor of a specific shelf, the display 1710 may display a message informing that the temperature is required to be adjusted, a message informing that foods should be moved to a freezer, or the like.

In addition, the display 1710 may display information recommending the cooking material based on the freshness of the food detected through the sensor. Also, the refrigerator 1700 may store health information of a user and manage the diet based on the information and the data measured in the sensor.

According to another embodiment of the disclosure, the sensor of the disclosure may be used in a medical field or a health care field. For example, the sensor may be used to diagnose a simple disease such as diabetes, heart disease, lung disease, etc. In addition, the sensor of the disclosure may be implemented as a breathalyzer by being used in measuring alcohol, and may be implemented as a sensor monitoring bad breath or body odor.

For a specific example, the sensor of the disclosure may be used to detect a specific material in blood. For example, the sensor of the disclosure may be used to diagnose the diabetes by measuring the concentration of blood sugar in blood and to prevent heart diseases by measuring the cholesterol (total amount, low-density lipoprotein (LDL), high-density lipoprotein (HDL)), to diagnose a cancer by detecting a cancer maker (CEA, AFP, CA19-9, CA-125, CA15-3, PSA), to measuring lung diseases by measuring level of lung, to diagnose a high blood pressure by measuring sodium, to diagnose an obesity, a hyperlipidemia, a heart disease by measuring triglycerides, to diagnose a kidney disease by measuring potassium, to diagnose a gout by measuring uric acid, to diagnose a myocardial infarction by measuring Troponon I, to measure c-reactive protein (CRP), and to determine a heart failure by measuring NT-proBNP. The value of the NT-proBNP is high if there is a heart function or a functional disorder. The sensor of the disclosure may be used for an early diagnosis of an acute myocardial infarction by measuring creatinine kinase (CK-MB) in blood.

The sensor of the disclosure may be used to measure cotisol which is a hormone related to various hormones in blood, for example, the stress, used to measure dihydrotestosterone which is the hormone related to a male pattern hair loss, used to measure parathyroid hormone related to an adjustment of a blood calcium level, used to measure female hormone (estradiol, progesterone) which affects a generative function and a sexual functioning, and affects other organs such as a bone so that a menopause female may be confirmed, and used to measure testosterone or growth hormone.

In addition, the sensor of the disclosure may be used to measure sodium, vitamin, serum protein (albumin) in blood, etc. so as to analyze nutritive conditions or eating habits, used to measure ethanol so as to measure a drinking index, used to measure vitamin C so as to measure antioxidative activity, and used to measure folic acid (Vitamin B9) that is involved in preventing anemia and synthesizing DNA.

In addition, the sensor of the disclosure may be used to detect the material not only in the blood but also in another body fluid. For example, the sensor may be used to measure lactic acid or pH of sweat, used to measure potassium concentration in sweat, used to measure blood sugar in tear or pH of tear, and used to measure blood sugar, ketone, blood, white blood cell, etc. in urine, or pH of urine.

In addition, the sensor of the disclosure may be used to measure various elements in expiration, for example, nitrogen monoxide (NO), pentane, ethane, aldehyde, carbon monoxide (CO), carbon dioxide (CO₂), acetone, ketone, alkanes, hydrogen, oxygen, nitrous oxide (N₂O), ammonia (NH₃), etc.

The nitrogen monoxide, pentane, and ethane in the expiration relate to an asthma, the ethanol and aldehyde relate to a drinking or a hangover, the carbon monoxide relates to a smoking, and the presence of the carbon dioxide may be used to determine whether there is breath. In addition, the acetone or ketone relate to diabetes, alkanes relate to heart disease, the hydrogen in the expiration relates to a glucose absorption problem, the concentration of the carbon dioxide, oxygen, and nitrous oxide in the expiration when a surgery is performed relate to a degree of anesthesia, the ammonia relates to a kidney disease, and carbon monoxide relates to an air pollution.

Also, the sensor of the disclosure may be used to detect the material that specifically causes an allergy to a user.

As illustrated above, the sensor of the disclosure may be used to measure various object of detections and the result sensed in the sensor may be provided to a user through various electronic apparatuses. For example, if a specific disease is diagnosed through the sensor, the sensing result of the sensor may be provided to a user as information regarding an exercise appropriate for the disease diagnosed in the wearable device.

In addition, the sensor of the disclosure may control the electronic apparatus as described above according to the sensing result by communicating with the electronic apparatus such as an automatic window, cleaner, air cleaner, an air conditioner, a humidifier, etc. For example, the sensor may perform a control operation such as a window ventilation, an air conditioner temperature adjustment, a humidifier humidity adjustment, an operation of an air conditioner according to a pollution level. In addition, the sensor of the disclosure may communicate with the electronic apparatus such as a smart medicine case, a smart cup, etc. and control so that the information for a guide for taking medicine (e.g., notification of a time for taking a medicine, notification of an amount of water when taking a medicine, etc.) is provided in the above apparatus.

The sensor using the indicator dye according to the above various embodiments is cheap, reusable by washing with water because it is resistant to water, may sensitively react to the detection object substance, and may be applied to various products because the structure thereof is simple. For example, the sensor of the disclosure may be included in the portable material of a user and used to measure the concentration of harmful gas in the place where a user presents, the concentration of user's bio-gas, etc. For a specific example, the sensor of the disclosure may be included in gloves, a band, a neckless, a bracelet, a ring, a hairband, an ear phone, an ear ring, clothes, etc.

Meanwhile, a method for controlling the sensor according to the above described various embodiments may be stored in a non-transitory readable medium. The non-transitory readable medium may be embedded and used in various devices. For example, there may be provided the non-transitory readable medium including a program for executing a controlling method of a sensor including the stage for determining a concentration of an object substance corresponding to the color of the pad by receiving light reflected from the pad including the composition according to the disclosure through a photo diode and the like.

The non-transitory readable medium is not a medium that stores data for a short moment such as a register, a cash and a memory and the like, but a medium that stores data semi-permanently and which is readable by an apparatus. Specifically, programs for performing the above-described various methods can be stored in a non-transitory readable medium such as a CD, a DVD, a hard disk, a Blu-ray disk, universal serial bus (USB), a memory card, ROM, or the like, and can be provided.

Although various embodiments of the disclosure have been illustrated and described hereinabove, the disclosure is not limited to the above-mentioned embodiments, and may be variously modified by those skilled in the art to which the disclosure pertains without departing from the scope and spirit of the disclosure as set forth in the accompanying claims. These modifications should also be understood to fall within the scope of the disclosure.

1. A sensor for measuring a concentration of an object substance by a color change, the sensor comprising:
a pad that is dried after being immersed in a solution containing an ionic substance consisting of an ionized indicator dye and ‘an ion having an opposite polarity to the ionized indicator dye between a cation and an anion constituting ionic liquid’; and
a support member to which the pad is attached.

2. The sensor as claimed in claim 1, wherein the pad in the support member is disposed for directly contacting washing water.

3. The sensor as claimed in claim 1, wherein the ionized indicator dye is generated by ionizing at least one of chlorophenol red, bromocresol green, bromophenol blue, bromothymol blue, cresol red, methyl orange, methyl red, phenol red, phenolphthalein or thymol blue.

4. The sensor as claimed in claim 1, wherein the ionic liquid is selected from at least one of imidazolium salt, phosphonium salt, pyrrolidinium salt, piperidinium salt, fluoroborate salt, fluorophosphates salt, bis(fluorosulfonyl)imide salt or bis(fluorosufonyl)amide salt.

5. The sensor as claimed in claim 1, wherein the pad consists of at least one of fiber, ceramic, paper or polymer.

6. The sensor as claimed in claim 1, wherein an adhesive substance is applied to one side of the support member.

7. The sensor as claimed in claim 1, further comprising:
a light receiver disposed between the pad and the support member for receiving light; and
a processor configured to determine a concentration of an object substance corresponding to a color of the pad based on light incident on the light receiver.

8. The sensor as claimed in claim 7, further comprising:
a light source for irradiating light to the pad.

9. The sensor as claimed in claim 7, further comprising:
a communicator;
wherein the processor controls the communicator to transmit sensing data corresponding to a color of the pad to another electronic apparatus.

10. A sensing system comprising:
a sensor including a pad dried after being immersed in a solution containing an ionic substance consisting of an ionized indicator dye and ‘an ion having an opposite polarity to the ionized indicator dye between a cation and an anion constituting ionic liquid’, and configured to transmit sensing data corresponding to a color of the pad to an external apparatus; and
an electronic apparatus configured to receive sensing data from the sensor and perform an operation corresponding to the received sensing data.

11. The sensing system as claimed in claim 10, wherein the electronic apparatus includes a display displaying information on a concentration of a substance sensed in the sensor based on the received sensing data.

12. The sensing system as claimed in claim 11, wherein the display displays at least one of air pollution information, noxious gas information, water pollution information, disease diagnosis information, food state information or disaster state notification information, according to a concentration of a substance sensed by the sensor, based on the sensing data.

13. The sensing system as claimed in claim 11, wherein the sensor is disposed to be adjacent to a filter for filtering a pollutant, and
wherein the electronic apparatus displays information on a degree of pollution of the filter based on the sensing data through the display.

14. The sensing system as claimed in claim 10, wherein the electronic apparatus is a smart phone, a wearable device, a refrigerator, a washing machine, a cleaner, an air cleaner, an air conditioner, or a humidifier.

15. A method for manufacturing a sensor including a pad of which color changes according to a concentration of an object substance, the method comprising:
preparing an aqueous solution in which an indicator dye is ionized;
adding ionic liquid to the aqueous solution;
adding a non-polar solvent to the aqueous solution to which ionic liquid is added and stirring the aqueous solution;
obtaining a solution containing the non-polar solvent and a substance dissolved in the non-polar solvent; and
drying a pad after immersing the pad in the obtained solution.
